(19) United States
(12) Patent Application Publication
(10) Pub. No.: US 2014/0156297 A1
(43) Pub. Date: Jun. 5, 2014

(54) COMPUTER PROGRAM, METHOD, AND SYSTEM FOR PHARMACIST-ASSISTED TREATMENT OF PATIENTS

(71) Applicant: AXELACARE HOLDINGS, INC., Lenexa, KS (US)

(72) Inventors: David Schaefer, Lenexa, KS (US); Ron Lindahl, Lenexa, KS (US)

(73) Assignee: AXELACARE HOLDINGS, INC., Lenexa, KS (US)

(21) Appl. No.: 14/100,254

(22) Filed: Dec. 9, 2013

Related U.S. Application Data
(63) Continuation-in-part of application No. 13/566,775, filed on Aug. 3, 2012.

(51) Int. Cl. G06F 19/00

(52) U.S. Cl. CPC G06F 19/3418
USPC 705/2

(57) ABSTRACT

A computer program for directing operation of a tablet computer or other portable electronic device operated by a caregiver while administering an in-home or outpatient treatment to a patient. The computer program comprises a code segment for receiving pre-treatment patient data representative of a condition of a patient before the patient receives a treatment; a code segment for receiving treatment patient data representative of a condition of the patient while or shortly after the patient receives the treatment; a code segment for transmitting at least some of the pre-treatment patient data and the treatment patient data from the portable electronic device to a remote computer while or shortly after the patient receives the treatment; and a code segment for receiving and displaying instructions from a doctor and instructions from a pharmacist that are provided in response to the transmitted data.

### RELATED APPLICATION

This non-provisional patent application is a continuation-in-part of earlier-filed U.S. patent application titled COMPUTER PROGRAM, METHOD AND SYSTEM FOR COLLECTING PATIENT DATA WITH A PORTABLE ELECTRONIC DEVICE, filed Aug. 3, 2012 and assigned application Ser. No. 13/566,775. This application claims priority benefit with regard to all common subject matter of the earlier-filed U.S. patent application. The earlier-filed application is hereby incorporated by reference in its entirety into the present application.

### BACKGROUND

The present invention relates to the collection, management, and mining of patient data for diseases such as chronic inflammatory demyelinating polyneuropathy (CIDP).

CIDP is an acquired immune-mediated inflammatory disorder of the peripheral nervous system. Diagnosis of CIDP is usually made through a clinical neurological examination. Patients often have a history of weakness, numbness, tingling, pain and difficulty in walking. Some may also experience fainting spells while standing up or burning pain in extremities and/or have sudden onset of back pain or neck pain radiating down the extremities, usually diagnosed as radicular pain. These symptoms are usually progressive and may be intermittent.

Early diagnosis and treatment of CIDP is crucial in preventing irreversible nervous system damage and improving functional recovery. However, CIDP is under-recognized and treated because it affects different patients in different ways. Lack of awareness and treatment of CIDP is also due to limitations of clinical trials. Although stringent research criteria exist for selecting patients to clinical trials, no generally agreed-on clinical diagnostic criteria exist for CIDP due to variations in symptoms and objective data.

Treatment of CIDP often includes intravenous immunoglobulin (IVIG), which may be prescribed alone or in combination with an immunosuppressant drug. IVIG is a blood product administered intravenously. It contains the pooled, polyvalent, IgG (immunoglobulin (antibody) G) extracted from the plasma of multiple blood donors. Although IVIG has shown to be effective in treating CIDP, significant evidence is lacking, mostly due to the heterogeneous nature of the disease and the low number of controlled trials. This is a problem because IVIG is extremely expensive. Insurance companies are therefore often reluctant to pay for IVIG even though it can help some patients. Even when IVIG is approved for use with patients, doctors have little guidance on proper dosing because of the heterogenous response to the drug amongst patients and limited published dosing studies or guidelines.

Similar problems exist for other diseases with heterogeneous symptoms and/or treatments, especially auto-immune related diseases.

### SUMMARY

The present invention solves the above-described problems and provides a distinct advance in the art of data collection, management, and mining for CIDP and other rare diseases. More particularly, the present invention provides a computer program, method, and system for collecting and managing data for diseases that allows doctors, pharmacists, and others to determine optimal IVIG dosages or other treatments for particular patients; enables doctors, pharmacists, and other caregivers to assess the efficacy of IVIG or other treatments on a particular patient in essentially real-time as the patient is being treated or between treatments; permits caregivers to alter a treatment regimen in essentially real-time or between treatments based on monitored results of the treatment regimen; and allows doctors, pharmacists, researchers, insurance companies and others to more easily and accurately collect and “mine” data for diseases to improve diagnosis and treatment of the diseases. Embodiments of the invention may also be used to capture data related to patient side-effects and to take photos of drugs to be administered, the administration site, and the patient before, during and after a treatment. Embodiments of the invention also permit caregivers to interactively question patients on their health status, conditions, activities, medications, medical events (infections, ER visits, health changes, falls, seizures, flare-ups, etc.), treatment compliance, cognitive abilities, etc.

Many people with CIDP receive IVIG infusions and other treatments at home under the care of nurses or other caregivers. Applicant has discovered that this is the optimal time to gather and analyze data relating to a treatment, a patient's condition, and the patient's response to the treatment because the data can be gathered in substantially real-time before, during, and after the treatment. Such data improves the diagnosis of CIDP and other diseases and can even be used to alter a treatment regimen in nearly real-time or between doses. The collection of such data during in-home treatments is also beneficial because clinical research is expensive and difficult to organize in hospitals or busy physician practice settings. Collection of data during in-home treatments also allows for a larger population of patients with the same disease to be studied, whereas a physician or institution may only see a few cases of the same disease on a routine basis.

An embodiment of the invention takes advantage of this discovery by providing a computer program for directing operation of a tablet computer or other portable electronic device operated by a caregiver while administering an in-home or outpatient treatment to a patient. The caregiver may use the portable electronic device to capture data and other information before, during, and after a medical treatment and then transmit the data to a remote computer system for analysis. The remote computer may then send the data, or otherwise make it available, to doctors, pharmacists, and other caregivers for the patient. The portable electronic device may also receive treatment instructions from a doctor and co-treatment instructions from a pharmacist that are based on the data collected by the caregiver.

An embodiment of the computer program comprises a code segment for receiving data representative of a condition of a patient before the patient receives a treatment (pre-treatment patient data); a code segment for receiving data representative of a condition of the patient during or shortly after the patient receives the treatment (treatment patient data); a code segment for transmitting at least some of the pre-treatment patient data and the treatment patient data from the portable electronic device to a remote computer while or shortly after the patient receives the treatment; and a code segment for receiving and displaying instructions from a doctor or a pharmacist that are provided in response to the transmitted data. The data representative of the condition of the patient both before and during a treatment may be gathered by a nurse or other clinician or even the patient himself.

The instructions received from the doctor may include changes to the treatment being administered to the patient such as changes to a medicine dosage, timing of infusions, and/or infusion rates and related treatments. The instructions received from the primary pharmacist may relate to a co-treatment to be administered to the patient along with the treatment. For example, the pharmacist instructions may relate to non-prescription medicines such as pain relievers, anti-inflammatory agents, or fever reducers to be administered to the patient before, during, or after the primary treatment ordered by the doctor. The pharmacist instructions may also relate to the timing of the infusions.

In some embodiments of the invention, the remote computer system may allow the doctor and pharmacist to view each other's instructions and/or notes. For example, if the doctor changes a medicine dosage, these instructions are sent both to the portable electronic device operated by the nurse or other caregiver administering the medicine and to a computer operated by the pharmacist. This allows the pharmacist to consider the doctor's instructions while providing the pharmacist's instructions. For example, if the doctor provides instructions to increase a medicine dosage and/or to increase the frequency of the medicine, the pharmacist may alter a co-treatment by increasing or otherwise changing the administration of a co-treatment medicine such as a pain killer.

In some embodiments of the invention, the computer program on the portable electronic device prioritizes, and if necessary, overrides instructions form the doctor or pharmacist. For example, the computer program may compare instructions from the doctor and pharmacist and override any instructions from the pharmacist that conflict with instructions from the doctor. Alternatively, the computer program may notify the doctor and pharmacist of the conflicting instructions, via the remote computer, and display the instructions on the portable electronic device only after the doctor has reviewed, approved, or modified the instructions.

The computer program that operates the portable electronic device may further comprise a code segment for receiving data representative of a condition of the patient after the treatment, including any instructions from the doctor, or pharmacist, have been completed (post-treatment patient data). The computer program may further comprise a code segment for comparing the post-treatment patient data to the pre-treatment patient data and/or the treatment patient data and for identifying changes in the condition of the patient based on the comparison. The computer program may further comprise a code segment for determining if the changes in the condition of the patient are greater than a threshold amount, and if they are, transmitting data representative of the changes to the remote computer.

Another embodiment of the invention is a computer program for directing operation of a computer system that receives data from a portable electronic device operated by a caregiver. The computer program comprises a code segment for receiving data representative of a medical treatment to be administered to a patient (medical data); a code segment for receiving data representative of a condition of the patient before the medical treatment (pre-treatment patient data); a code segment for receiving data representative of a condition of the patient after the patient begins receiving the treatment (treatment patient data); and a code segment for correlating the medical data with the pre-treatment patient data and the treatment patient data to allow an investigator to determine an efficacy of the medical treatment. The computer program may further comprise a code segment for receiving data representative of a condition of the patient after the medical treatment is altered in accordance with instructions from a doctor (post-treatment patient data); a code segment for comparing the post-treatment patient data to the pre-treatment patient data and/or the treatment patient data and for identifying changes in the condition of the patient based on the comparison; and a code segment for correlating the changes with the medical data. Data from other sources may also be incorporated with the medical data described above.

The data representative of the condition of the patient before, during, or after a treatment may measure or quantity the patient's physical condition, a disability score, a quality of life measure, or other measures. For example, the data may be gathered by administering a Jamar grip strength test or a timed-up-and-go (TUGS) TEST. The data may also represent results of a RODS disability score, an Overall Neuropathy Limitations Scale (ONLS) disability score, a modified fatigue severity score (MFSS), a Visual Analog Scale (VAS) pain severity scale, or a quality of life measure. The data may also represent a quality of life measure such as the results of a standard quality of life measure test. The data may also represent the patient's glucose level, total vital capacity, weight, blood pressure, etc. The data may be gathered manually or automatically by the caregiver, the patient, or even family members or friends of the patient.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram that illustrates persons and/or entities that may be involved with aspects of the present invention;

FIG. 2 is a schematic diagram of exemplary computer and communications equipment that may be used to implement embodiments of the invention;

FIG. 3 is a flow diagram illustrating steps in a method of the invention and/or code segments in a computer program of the invention;

FIG. 4 is a flow diagram illustrating steps in another method of the invention and/or code segments in another computer program of the invention;

FIG. 5 is an exemplary screen display that may be presented by one or more computer programs of the present invention;

FIG. 6 is another exemplary screen display that may be presented by one or more computer programs of the present invention;

FIG. 7 is another exemplary screen display that may be presented by one or more computer programs of the present invention;

FIG. 8 is another exemplary screen display that may be presented by one or more computer programs of the present invention; and

FIG. 9 is another exemplary screen display that may be presented by one or more computer programs of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, act, etc. described in one embodiment may also be included in other embodiments, but is not necessarily included. Thus, the present technology can include a variety of combinations and/or integrations of the embodiments described herein.

The present invention provides various embodiments of a computer program, method, and system for collecting and managing data for rare diseases. The invention allows doctors to determine optimal IVIG dosages or other treatments for particular patients; enables doctors and other caregivers to assess the efficacy of IVIG or other treatments on a particular patient; permits caregivers to alter a treatment regimen based on monitored results of the treatment regimen; and allows doctors, insurance companies and others to more easily and accurately collect and “mine” data for rare diseases to improve diagnosis and treatment of the diseases. Some embodiments of the invention allow caregivers to assess the efficacy of treatments and alter treatment regimens in essentially real-time; however, such assessments and treatment decisions may also be made between treatment sessions or at other intervals.

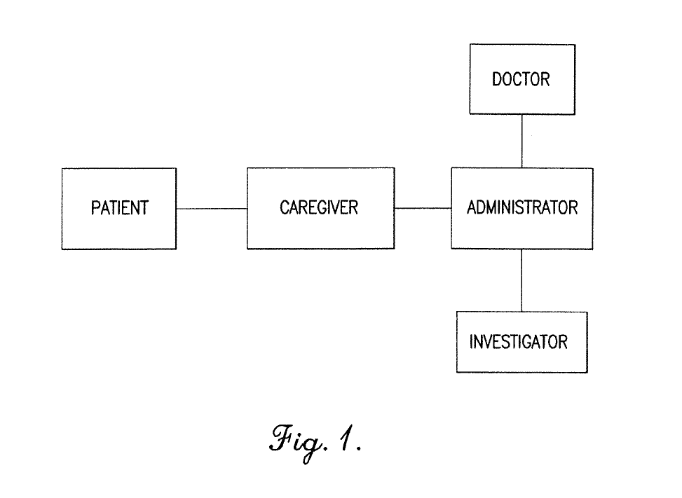

FIG. 1 is a block diagram that illustrates the relationships between persons and/or entities that may be involved with aspects of the invention. The entities include a patient, a caregiver, a doctor, a pharmacist, an administrator, and an investigator. The invention may of course be used with multiple patients, caregivers, etc., but the description below focuses on one of each for purposes of describing embodiments of the invention.

The patient may be any person suffering from a disease such as CIDP. Other diseases for which data may be collected, analyzed, etc. with the present invention include: Myasthenia Gravis (MG), Multiple Sclerosis (MS), Multifocal Motor Neuropathy (MMN), Dermatomyositis, Polymyositis, Guillain-Barre Syndrome (GBS), Primary Immune Disease (PIDD or PID), Alzheimer's disease, Transplantation, Pemphigus and Pemphigoid, Common Variable Immuno Deficiency (CVID), Toxic/Inflammatory Neuropathy, Small Fiber Neuropathy, Hypogammaglobulinemia, Stiff Person Syndrome, All peripheral neuropathies, Neonatal Alloimmune Thrombocytopenia (NAIT), Autoimmune Neuropathies, Immune thrombocytopenia purpraturea (ITP), IgG deficiency, Lou Gehrig's disease (ALS), Autism, Severe asthma, PANDA's disease, Hemophilia, Sarcodoisis, Scleroderma, and Heart Failure and other diseases which may be treated with IVIG, Subcutaneous Immunoglobulin (SCIG), and other drugs administered intravenously.

The caregiver may be a nurse, a nurse practitioner, a doctor, a therapist, a medical assistant, or any one else authorized to give in-home or outpatient care to the patient. Data may also be collected from patients, relatives, etc.

The doctor may be a medical doctor or other person who has prescribed IVIG and/or some other medical treatment to the patient. Typically, the caregiver works with the patient under the guidance of the doctor.

The pharmacist may be anyone who fills prescriptions for IVIG and/or other medical treatments prescribed by the doctor. The pharmacist may also recommend co-treatments such as pain killers and provide certain authorized changes to the doctor's prescriptions such as reducing the frequency of administration of a medicine.

The administrator may be any person or entity that operates a computer system that can be accessed by the caregiver, doctor, and/or investigator as described below. The administrator may be, for example, a physician's office administrator, a hospital, insurance provider, a health care company that provides in-home or outpatient infusion services such as AxelaCare of Lenexa, Kans., or a government agency involved in research, patient care, or care administration.

The investigator may be any person or entity that “mines” or otherwise uses data collected by the present invention. The investigator may be, for example, a drug company, an insurance company, a hospital, a research group, an individual doctor, or nursing agency.

In some embodiments, the persons and entities shown in FIG. 1 and described herein may be related or even combined. For example, the administrator may be a hospital at which the doctor and/or caregiver work. Similarly, the doctor and the investigator and/or the caregiver and the doctor may be the same persons.

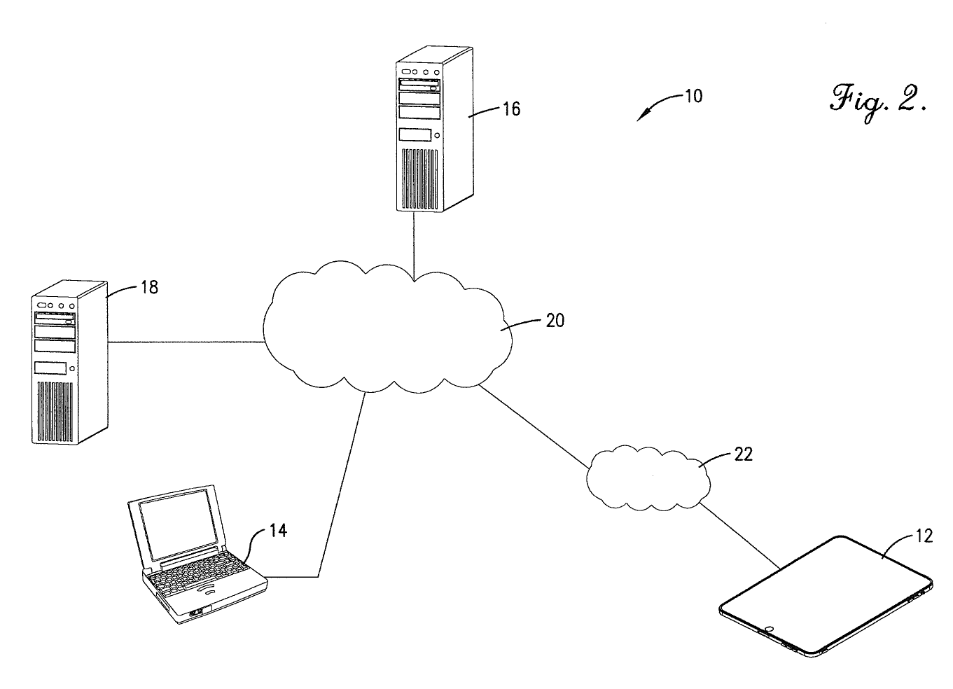

Aspects of the invention can be implemented with computer hardware, software, firmware, or a combination thereof. In one embodiment, aspects of the invention may be at least partially implemented with a system of computer and communications equipment broadly referred to by the numeral 10 in FIG. 2. An embodiment of the computer and communications equipment 10 includes a portable electronic device 12 operated by the caregiver, a computer 14 operated by or for the doctor, a computer 15 operated by or for the pharmacist, a computer system 16 operated by or for the administrator, a computer system 18 operated by or for the investigator, a communications network 20, and a wireless telecommunications network 22. The components of the computer and communication equipment 10 illustrated and described herein are merely examples of equipment that may be used to implement embodiments of the present invention and may be replaced with other equipment without departing from the scope of the present invention.

The portable electronic device 12 may be any computer device used by the caregiver while providing treatment to the patient that can be programmed to access the computer system 16 via the communications network 20, the wireless network 22, and/or any other network. For example, the portable electronic device 12 may be a tablet computer such as those sold by Apple, Motorola, Samsung or Hewlett Packard. The portable electronic device may also be a laptop computer or other portable computer or even a “smart” phone such as those manufactured by Apple®, Blackberry®, or Motorola®. The portable electronic device includes or can access an Internet browser and a conventional Internet connection such as a wireless broadband connection, a modem, DSL converter, or ISDN converter so that it can access the computer system 16 via the communications networks 20 and/or 22. The portable electronic device 12 may also include a global navigation system receiver such as a GPS receiver.

The computer 14 may be any computer device used by or for the doctor to monitor or otherwise participate in a treatment administered to the patient that can be programmed to access the computer system 16 via the communications network 20, the wireless network 22, and/or any other network. For example, the computer 14 may be a tablet computer such as those sold by Apple, Motorola, Samsung or Hewlett Packard, a desktop computer, laptop computer, or other portable computer, or even a “smart” phone such as those manufactured by Apple®, Blackberry®, or Motorola®. The computer 14 includes or can access an Internet browser and a conventional Internet connection such as a wireless broadband connection, a modem, DSL converter, or ISDN converter so that it can access the computer system 16 via the communications networks 20 and/or 22.

The computer 15 may be any computer device used by or for the pharmacist to monitor or otherwise participate in a treatment or co-treatment administered to the patient that can be programmed to access the computer system 16 via the communications network 20, the wireless network 22, and/or any other network. For example, the computer 15 may be a tablet computer such as those sold by Apple, Motorola, Samsung or Hewlett Packard, a desktop computer, laptop computer, or other portable computer, or even a “smart” phone such as those manufactured by Apple®, Blackberry®, or Motorola®. The computer 15 includes or can access an Internet browser and a conventional Internet connection such as a wireless broadband connection, a modem, DSL converter, or ISDN converter so that it can access the computer system 16 via the communications networks 20 and/or 22.

The computer system 16 receives and stores data and other information received from the caregiver, doctor, pharmacist and/or other persons and permits the exchange of such data between the parties. The computer system 16 may also implement one or more computer programs for performing some of the functions described herein and may provide a web-based portal that can be accessed by the other devices in the equipment 10.

Embodiments of the computer system 16 may include one or more servers such as a web server, a database server, an application server, and/or an FTP server running Windows; LAMP (Linux, Apache HTTP server, MySQL, and PHP/Perl/Python); Java; AJAX; NT; Novel Netware; Unix; or any other software system. The computer system 16 includes or has access to computer memory and other hardware and software for receiving, storing, accessing, and transmitting data and other information as described below. The computer system 16 also includes conventional web hosting operating software, searching algorithms, an Internet connection, and is assigned a URL and corresponding domain name such as “axelacare.com” so that it can be accessed via the Internet in a conventional manner.

The number and type of servers in the computer system 16 is a matter of design choice and may depend on the number of patients, caregivers, doctors, and/or pharmacists, served by the computer system 16. Thus, the invention is not limited to the specific servers and other equipment described and illustrated herein.

The computer system 16 may also host or store a database of patients, caregivers, and doctors, and/or pharmacists using the present invention. For example, the database may include the names, addresses, medical histories, age, sex, etc. of all the patients and similar information for others. The computer system may also host and support software and services of proprietary mobile application providers such as Google, Apple, and Blackberry and may store the computer program that is loaded on the portable electronic device 12 used by the caregiver as described in more detail below.

The computer system 18 may be any computer device operated by the investigator to access and mine the patient data, treatment data, and other data stored on the computer system 16. For example, the computer 18 may be a tablet computer such as those sold by Apple, Motorola, Samsung or Hewlett Packard, a desktop computer, laptop computer, or other portable computer, or even a “smart” phone such as those manufactured by Apple®, Blackberry®, or Motorola®. The computer 18 includes or can access an Internet browser and a conventional Internet connection such as a wireless broadband connection, a modem, DSL converter, or ISDN converter so that it can access the computer system 16 via the communications networks 20 and/or 22.

Although only one of each of the portable electronic device 12, computer 14, computer 15, computer system 16, and computer 18 is shown in FIG. 2, any number of such computer devices may be provided.

The communications network 20 is preferably the Internet but may be any other communications network such as a local area network, a wide area network, or an intranet. The wireless network 22 may be any network capable of supporting wireless communications such as the wireless networks operated by AT&T, Verizon, or Sprint. The wireless network may include conventional switching and routing equipment. The communications network 20 and wireless network 22 may also be combined or implemented with several different networks.

Embodiments of the present invention also comprise one or more computer programs stored in or on computer-readable medium residing on or accessible by the portable electronic device 12, the computer system 16, or other computer equipment. The computer programs may comprise listings of executable instructions for implementing logical functions in the computer equipment. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

An embodiment of the invention includes a program or programs that implement functions and features of the invention on the portable electronic device 12. Another embodiment of the invention includes one or more computer programs that implement functions and features of the invention on the computer system 16.

The computer program for directing operation of the portable electronic device 12 may be used while the caregiver administers an in-home or outpatient treatment to a patient. The caregiver may use the portable electronic device 12 to capture data and other information before, during, and after a medical treatment and then transmit the data to the computer system 16 for analysis. The portable electronic device 12 may also receive treatment instructions from the doctor and/or pharmacist that are based on the data collected by the caregiver.

An embodiment of the computer program comprises a code segment for receiving data representative of a condition of the patient before the patient receives the treatment (referred to herein as “pre-treatment patient data”); a code segment for receiving data representative of a condition of the patient while or shortly after the patient receives the treatment (referred to herein as “treatment patient data”); and a code segment for transmitting at least some of the pre-treatment patient data and the treatment patient data from the portable electronic device to a remote computer while or shortly after the patient receives the treatment.

The computer program that operates the portable electronic device 12 may also comprise a code segment for receiving and displaying instructions from the doctor and/or pharmacist that are provided in response to the transmitted data. The instructions from the doctor may include changes to the treatment being administered to the patient such as changes to a dosage of medicine. The instructions received from the pharmacist may relate to a co-treatment to be administered to the patient along with the treatment. For example, the pharmacist instructions may relate to non-prescription medicines such as pain relievers, anti-inflammatory agents, or fever reducers to be administered to the patient before, during, or after the primary treatment ordered by the doctor. The pharmacist instructions may also relate to the timing of the infusions.

In some embodiments of the invention, the remote computer system 16 may allow the doctor and pharmacist to view each other's instructions and/or notes. For example, if the doctor changes a medicine dosage, these instructions are sent both to the portable electronic device 12 operated by the nurse or other caregiver administering the medicine and to the computer 15 operated by the pharmacist. This allows the pharmacist to consider the doctor's instructions while providing his or her instructions. For example, if the doctor provides instructions to increase a medicine dosage and/or to increase the frequency of the medicine, the pharmacist may alter a co-treatment by increasing or otherwise changing the administration of a co-treatment medicine such as a pain killer.

In some embodiments of the invention, the computer program on the portable electronic device 12 prioritizes, and if necessary, overrides certain instructions. For example, the computer program may compare instructions from the doctor and pharmacist and override any instructions from the pharmacist that conflict with instructions from the doctor. Alternatively, the computer program may notify the doctor and pharmacist of the conflicting instructions, via the remote computer, and display the instructions on the portable electronic device only after the doctor has reviewed, approved, or modified the instructions.

The computer program on the portable electronic device 12 may further comprise a code segment for receiving data representative of a condition of the patient after the treatment and/or co-treatment (referred to herein as “post-treatment patient data”), including any instructions from the doctor or pharmacist, have been completed. The computer program may further comprise a code segment for comparing the post-treatment patient data to the pre-treatment patient data or the treatment patient data and for identifying changes in the condition of the patient based on the comparison. The computer program may further comprise a code segment for determining if the changes in the condition of the patient are greater than a threshold amount, and if they are, transmitting data representative of the changes to the remote computer.

The computer program or programs that direct operation of the computer system 16 coordinate the transfer of data to and from the portable electronic device 12 and the computer 14 and facilitate the analysis and mining of the collected data as described in more detail below. The computer program comprises a code segment for receiving, from the portable electronic device 12, data representative of a medical treatment to be administered to a patient (referred to herein as “medical data”); a code segment for receiving the pre-treatment patient data discussed above; a code segment for receiving the treatment patient data discussed above; and a code segment for correlating the medical data with the pre-treatment patient data and the treatment patient data to allow an investigator to determine an efficacy of the medical treatment. The computer program may further comprise a code segment for receiving the post-treatment data discussed above; a code segment for comparing the post-treatment patient data to the pre-treatment patient data and the treatment patient data and for identifying changes in the condition of the patient based on the comparison; and a code segment for correlating the changes with the treatment data.

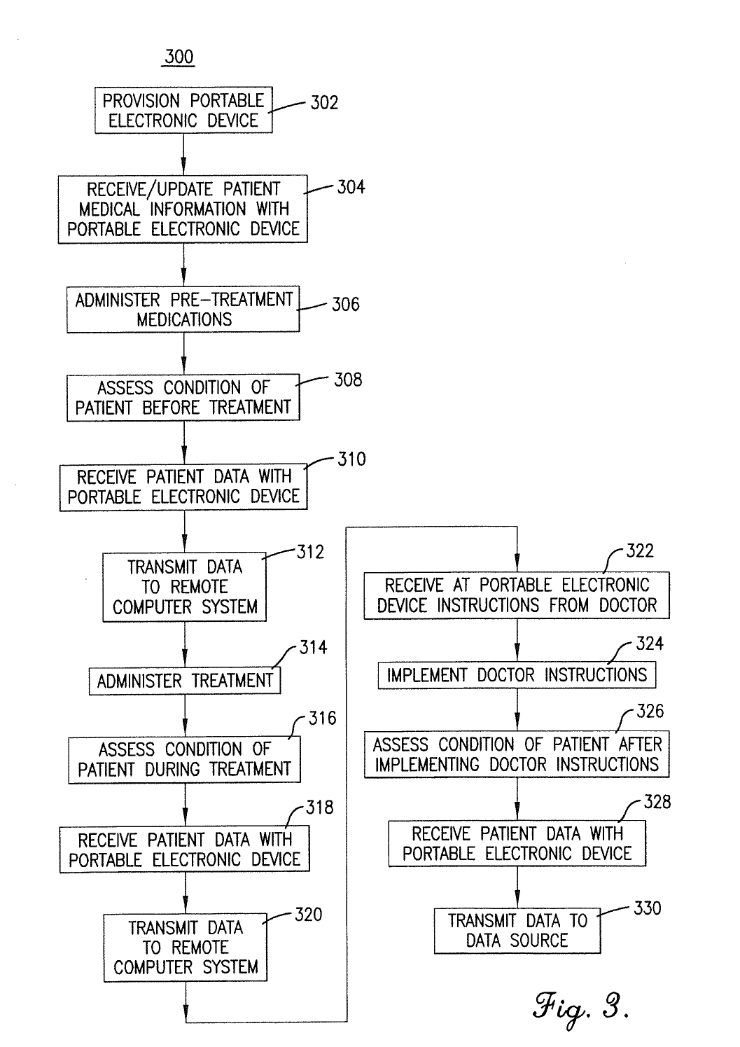

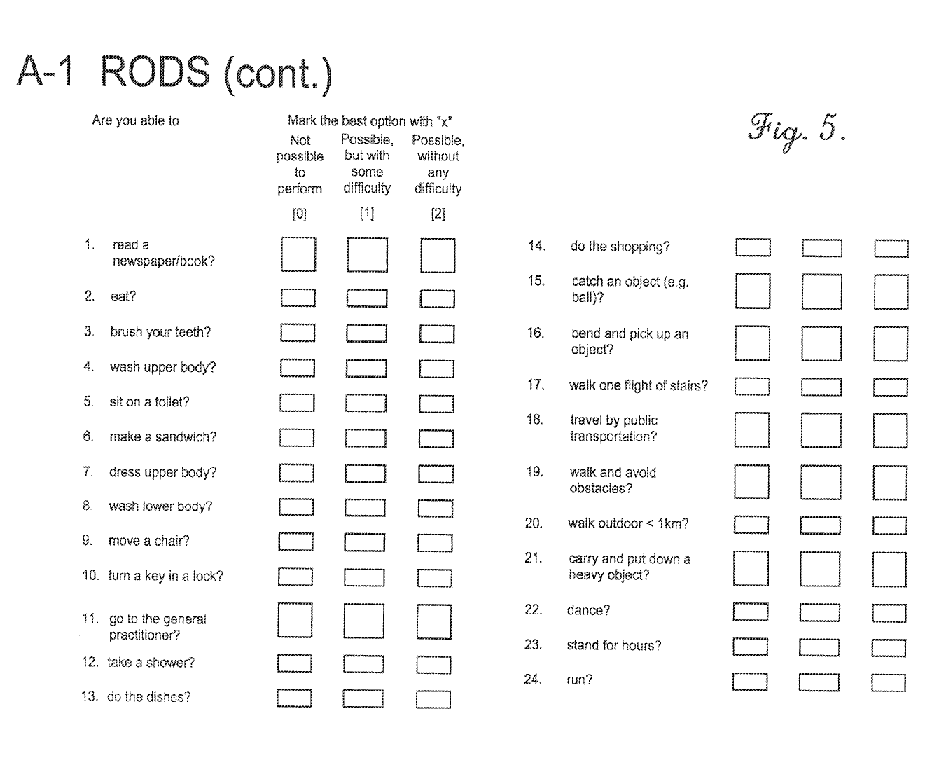

The flow chart of FIG. 3 shows the functionality and operation of an exemplary implementation of the present invention in more detail. In this regard, some of the blocks of the flow chart may represent steps in a method 300 and/or a module segment or portion of code of the computer program that operates the portable electronic device 12. In some alternative implementations, the functions noted in the various blocks may occur out of the order depicted in FIG. 3. For example, two blocks shown in succession in FIG. 3 may in fact be executed substantially concurrently, or the blocks may sometimes be executed in the reverse order depending upon the functionality involved. Some of the module segments or code of the computer programs may display, populate, or otherwise enable the screen displays shown in FIGS. 5-9.

The method 300 may begin when the portable electronic device 12 is provisioned with the computer program as depicted in step 302. This may be done in any conventional manner. For example, the portable electronic device 12 may be pre-loaded with the computer program or the caregiver or other user may access the computer system 16 or another computing device associated with the system to download the program.

Once the portable electronic device 12 is provisioned with the computer program, the caregiver may use the device to assist with treating a patient and to interact with the computer system 16 as described herein. When the computer program on the device 12 is opened, the program may establish communications with the computer system 16 and display a log-in screen in a conventional manner.

The caregiver may then access medical information for the patient by retrieving such information from the computer system 16 as depicted in step 304. The caregiver may also receive updated and/or new medical information from the patient, enter it into the portable electronic device 12, and upload it to the computer system 16.

The caregiver may then administer pre-treatment medications, if any, to the patient as depicted in step 306. Such pre-treatment medications may include for example, pain-killers, anti-nausea medications, anti-rash medications, anti-itch medications, disinfectants, sterilization agents, etc. As explained below, the pharmacist may alter the administration of these pre-treatment medications after reviewing data gathered during the primary treatment of the patient.

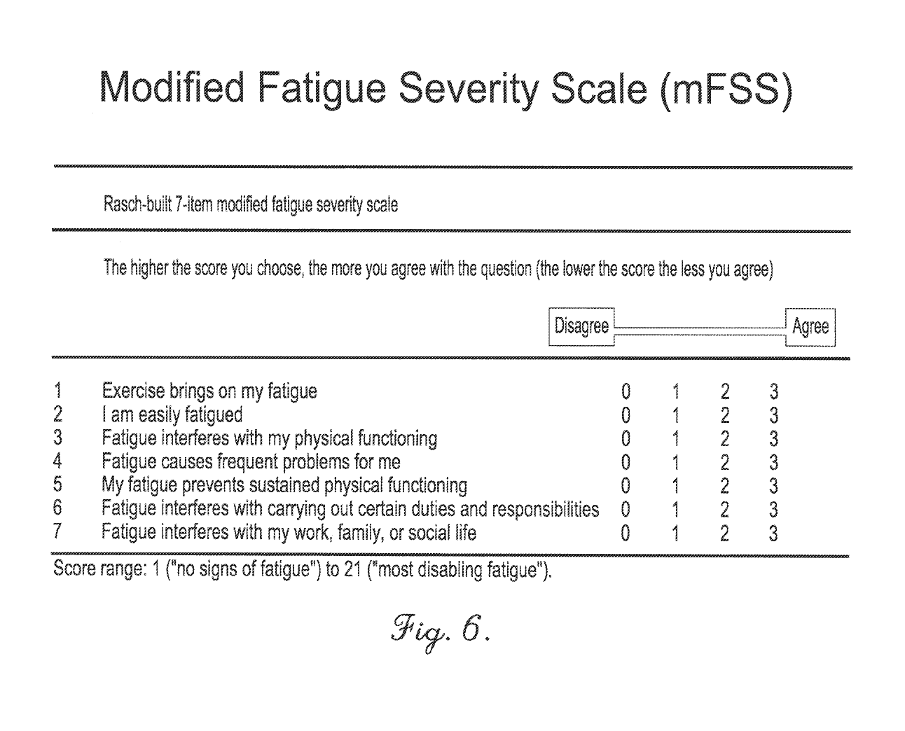

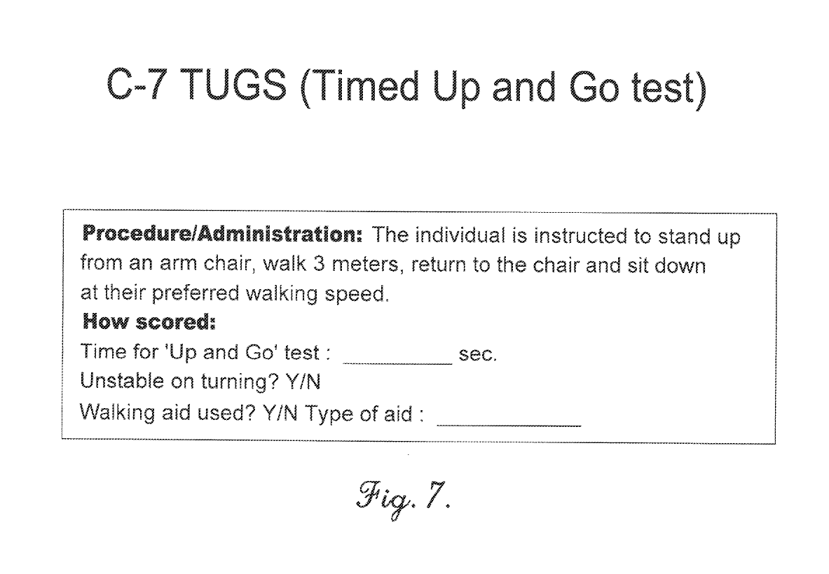

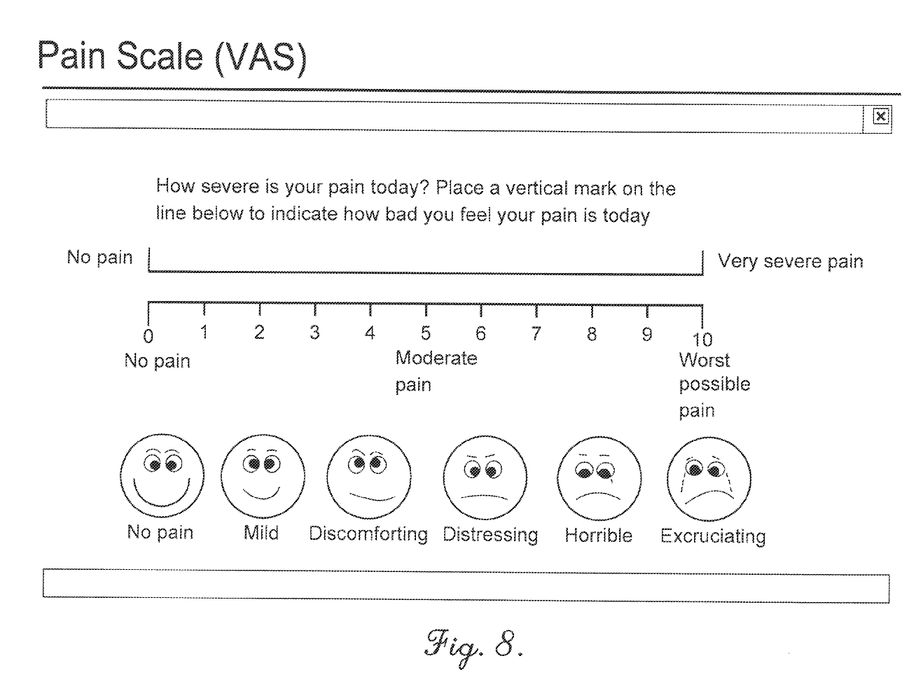

The caregiver then assesses the condition of the patient before beginning the primary treatment as depicted in step 308 and enters pre-treatment patient data into the portable electronic device representative of the patient's condition as depicted in step 310. For example, the caregiver may measure the patient's heart rate, body temperature, and/or other vital signs and enter representative data into the portable electronic device. The computer program may also prompt the caregiver to administer a RODS test as shown in FIG. 5, a modified fatigue severity scale (MFSS) test as shown in FIG. 6, a timed up and go (TUG) test as shown in FIG. 7, and/or a self-evaluated pain scale test as shown in FIG. 8 and enter data representative of results of these tests. The computer program may also prompt other tests such as a grip strength test.

The pre-treatment patient data entered into or captured by the portable electronic device 12 is then transmitted to the computer system 16 as depicted in step 312. The computer system may store such data in memory and may transmit the data to the computer 14 operated by the doctor and the computer 15 operated by the pharmacist or otherwise allow the doctor and pharmacist to access the data.

The caregiver may then administer a primary treatment to the patient as depicted in step 314. For example, the caregiver may begin an IVIG infusion and/or administer other medicine.

The caregiver then assesses the condition of the patient during the primary treatment as depicted in step 316 and enters treatment patient data into the portable electronic device 12 representative of the patient's condition as depicted in step 318. For example, the caregiver may re-measure the patient's heart rate, body temperature, and/or other vital signs and enter representative data or may administer a RODS test, modified fatigue severity scale (MFSS) test, timed up and go (TUG) test, a self-evaluated pain scale test, and/or a grip strength test and enter the results of the tests.

The treatment patient data entered into or captured by the portable electronic device 12 is then transmitted to the computer system 16 as depicted in step 320. The computer system may store such data in memory and may transmit the data to the computer 14 operated by the doctor and/or the computer 15 operated by the pharmacist or otherwise allow the doctor or pharmacist to access the data.

The doctor and/or pharmacist may access the pre-treatment patient data and/or treatment patient data at any time to assess the patient's condition, determine the efficacy of the medical treatment administered to the patient, and/or provide changes to the treatment. For example, if the doctor believes a current treatment regimen should be changed based on the patient's condition at any stage of the treatment, the doctor can provide instructions to the computer system 16, and the computer system 16 sends such instructions to the portable electronic device 12 operated by the caregiver as depicted in step 322. Similarly, if the pharmacist wishes to prescribe a co-treatment medicine because of the patient's condition, the pharmacist can provide instructions to the computer system 16 so that the instructions can be sent to the portable electronic device 12. Such instructions may be provided in real-time, between treatment sessions, or at other intervals. As mentioned above, the computer system 16 may allow the doctor and pharmacist to view each other's instructions or notes.

The caregiver may then implement the doctor's or pharmacist's instructions, if any, as depicted in step 324. For example, the caregiver may alter a dosage of IVIG or other medicine or perform other treatments in accordance with the doctor's or pharmacist's instructions.

In some embodiments of the invention, the computer program on the portable electronic device 12 prioritizes, and if necessary, overrides certain instructions. For example, the computer program may compare instructions from the doctor and pharmacist and override any instructions from the pharmacist that conflict with instructions from the doctor.

The caregiver then assesses the condition of the patient after implementing the doctor's instructions as depicted in step 326 and enters post-treatment patient data into the portable electronic device 12 as depicted in step 328. For example, the caregiver may re-measure the patient's heart rate, body temperature, and/or other vital signs and enter representative data and/or may administer a RODS test, a modified fatigue severity scale (MFSS) test, a timed up and go (TUG) test, a self-evaluated pain scale test, quality of life questionnaire (SF-36 questionnaire for example), and/or a grip strength test and enter the results.

The post-treatment patient data entered into or captured by the portable electronic device 12 is then transmitted to the computer system 16 as depicted in step 330. The computer system may store such data in memory and may transmit the data to the computer 14 operated by the doctor or otherwise allow the doctor to access the data. The data and other data may also be accessed and “mined” by the investigator. For example, patient data from multiple patients may be aggregated to create cohorts based on disease, condition, therapy. Such data may be mined to compare response (benefit as measured by assessments and tests) to therapy, comparing patient response vs. changes in doses, discontinued therapy, expected outcomes, etc. The data may also be mined to compare treatment strategies such as maintenance dosing, therapy, crisis dosing, dose response to condition changes, etc. The data may also be used to create drug v. benefit titration curves, time to response curves, or sensitization non-response dynamics curves.

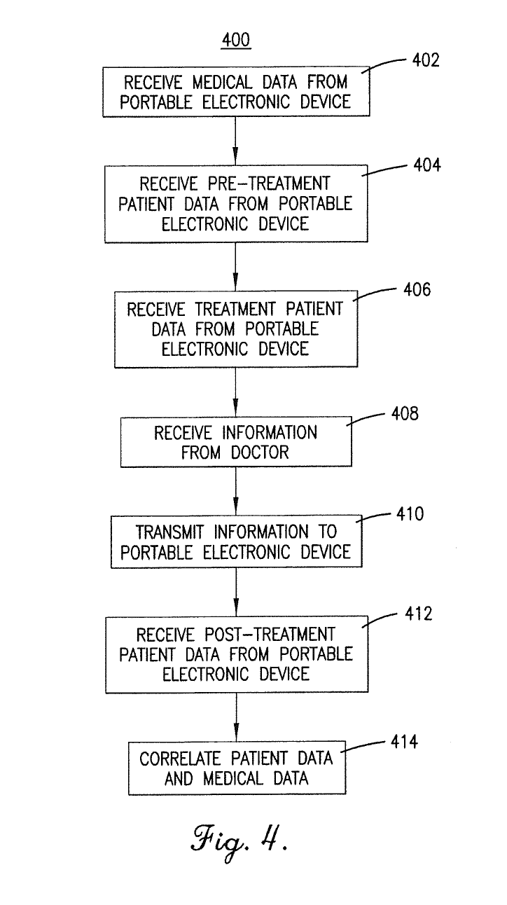

The flow chart of FIG. 4 shows the functionality and operation of another exemplary implementation of the present invention in more detail. In this regard, some of the blocks of the flow chart may represent steps in a method 400 and/or a module segment or portion of code of the computer programs that operate the computer system 16. In some alternative implementations, the functions noted in the various blocks may occur out of the order depicted in FIG. 4. For example, two blocks shown in succession in FIG. 4 may in fact be executed substantially concurrently, or the blocks may sometimes be executed in the reverse order depending upon the functionality involved.

The method 400 may begin when the computer system 16 receives medical data representative of a medical treatment to be administered to a patient as depicted in step 402. The medical data may be gathered by the caregiver while using the portable electronic device 12 as described above and may be transmitted from the portable electronic device to the computer system 16. The medical data may include, for example, the patient's name and other personal information and details of the treatment to be provided to the patient.

The computer system 16 then receives pre-treatment patient data from the portable electronic device as depicted in step 404. The pre-treatment patient data may be gathered when the caregiver assesses the condition of the patient before beginning a primary treatment and enters the data into the portable electronic device. For example, the pre-treatment data may represent the patient's heart rate, body temperature, and/or other vital signs and/or results of a ROD's test, a modified fatigue severity scale (MFSS) test, a timed up and go (TUG) test, a self-evaluated pain scale test, a quality of life questionnaire, and/or other tests such as a grip strength test.

The computer system 16 then receives treatment patient data from the portable electronic device as depicted in step 406. The treatment patient data may be gathered when the caregiver assesses the condition of the patient during or after a primary treatment or co-treatment and enters the data into the portable electronic device. For example, the treatment data may represent the patient's heart rate, body temperature, and/or other vital signs and/or results of a ROD's test, a modified fatigue severity scale (MFSS) test, a timed up and go (TUG) test, a self-evaluated pain scale test, a quality of life questionnaire, and/or other tests such as a grip strength test.

The computer system 16 then receives information from the doctor and/or the pharmacist as depicted in step 408. The information may be received from the doctor or pharmacist after the doctor or pharmacist accesses the pre-treatment patient data and the treatment patient data to assess the patient's condition, determine the efficacy of the medical treatment administered to the patient, and possibly provide changes to the treatment. For example, if the doctor or pharmacist believes a current treatment regimen or co-treatment should be changed based on the pre-treatment patient data and/or the treatment patient data, the doctor or pharmacist can provide instructions to the computer system 16.

The computer system 16 then transmits the doctor or pharmacist instructions and possibly other instructions to the portable electronic device 12 as depicted in step 410. The instructions are sent to the portable electronic device as soon as they are received from the doctor or pharmacist so that the caregiver, doctor and/or pharmacist can monitor the patient's condition and alter a medial treatment or co-treatment in substantially real-time during the medical treatment.

The computer system 16 then receives post-treatment patient data from the portable electronic device as depicted in step 412. The post-treatment patient data may be gathered when the caregiver assesses the condition of the patient after completing a primary treatment or co-treatment, including any changes to the primary treatment in accordance with the doctor's or pharmacist's instructions and enters the pre-treatment patient data into the portable electronic device. For example, the post-treatment data may represent the patient's heart rate, body temperature, and/or other vital signs and/or results of a ROD's test, a modified fatigue severity scale (MFSS) test, a timed up and go (TUG) test, a self-evaluated pain scale test, a quality of life questionnaire, and/or other tests such as a grip strength test after the medical treatment and/or co-treatment is complete.

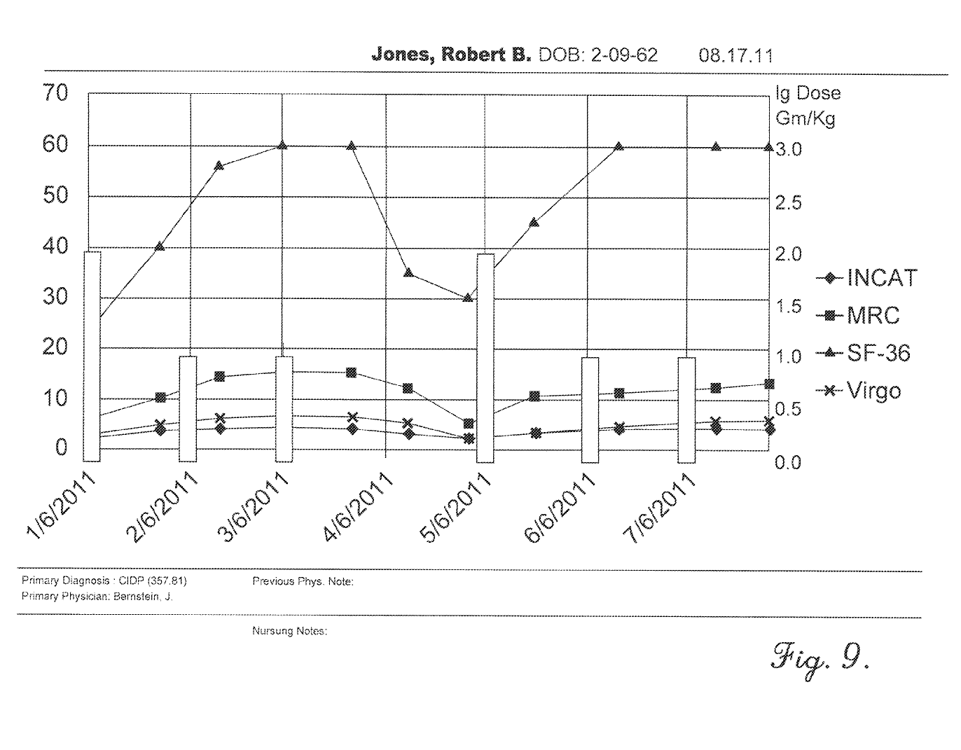

The computer system 16 then correlates the medical data, pre-treatment patient data, treatment patient data, and post-treatment patient data as depicted in step 414. For example, the computer system may create charts, spreadsheets, or graphs such as the one shown in FIG. 9 that shows the relationships between the various data received from the portable electronic device 12 and the medical treatment administered to the patient. The charts, graphs etc. may compare a medicine dose vs. patient response, a percent change in a disability over time, etc.

The computer program that operates the portable electronic device 12 and/or the computer program that operates the computer system 16 may also compare the entered data and provide alerts when the data changes. For example, the portable electronic device program may compare the treatment patient data to the pre-treatment patient data and determine if the data has changed more than a threshold amount such as 5%, 10% or 20%. If it has, the portable electronic device 12 may automatically transmit and alert to the computer system 16, which may in turn send the alert to the doctor.

The above-described embodiments of the invention may also be used to capture data related to patient side-effects (both patient-observed and nurse-observed), and data related to drug administration, time, infusion rates, total dosage, etc. Embodiments of the invention may also be used to take photos and other images of drugs to be administered, the administration site, and the patient. Such photos may then be uploaded to the remote computer for viewing by a doctor or other person to be considered when evaluating and/or charging a treatment.

Although the invention has been described with reference to the preferred embodiment illustrated in the attached drawing figures, it is noted that equivalents may be employed and substitutions made herein without departing from the scope of the invention as recited in the claims. For example, although embodiments of the invention may be implemented with the computer and communications equipment described herein, the invention is not limited to this particular computer and communications equipment.

Having thus described the preferred embodiment of the invention, what is claimed as new and desired to be protected by Letters Patent includes the following:

1. A computer program stored on non-transitory computer-readable medium for directing operation of a portable electronic device operated by a caregiver while administering a treatment to a patient, the computer program comprising:
a code segment for receiving with the portable electronic device pre-treatment patient data representative of a condition of the patient before the patient receives the treatment;
a code segment for receiving with the portable electronic device treatment patient data representative of a condition of the patient while or shortly after the patient receives the treatment;
a code segment for transmitting at least some of the pre-treatment patient data and the treatment patient data from the portable electronic device to a remote computer while or shortly after the patient receives the treatment; and
a code segment for receiving and displaying on the portable electronic device instructions from a doctor and instructions from a pharmacist that are provided in response to the transmitted data.

2. The computer program set forth in claim 1, wherein the pre-treatment patient data and treatment patient data comprise results of a disability survey given to the patient.

3. The computer program set forth in claim 1, wherein the pre-treatment patient data and treatment patient data comprise results of a fatigue survey given to the patient.

4. The computer program set forth in claim 1, wherein the pre-treatment patient data and treatment patient data comprise results of a grip strength test given to the patient.

5. The computer program set forth in claim 1, wherein the pre-treatment patient data and treatment patient data comprise results of a timed up and go (TUGS) test given to the patient.

6. The computer program set forth in claim 1, wherein the instructions received from the doctor are changes to the treatment being administered to the patient and the instructions received from the pharmacist are related to a co-treatment to be administered to the patient along with the treatment.

7. The computer program set forth in claim 1, wherein the instructions received from the doctor are dosage instructions for a prescription medicine being administered to the patient as part of the treatment and the instructions received from the pharmacist are dosage instructions for a non-prescription medicine to be administered to the patient before, during, or after the treatment.

8. The computer program set forth in claim 1, further comprising a code segment for receiving with the portable electronic device post-treatment patient data representative of a condition of the patient after the treatment, including any instructions from the doctor and instructions from the pharmacist, have been completed.

9. The computer program set forth in claim 8, further comprising a code segment for comparing the treatment patient data to the pre-treatment patient data and for identifying changes in the condition of the patient based on the comparison.

10. The computer program set forth in claim 9, further comprising a code segment for determining if the changes in the condition of the patient are greater than a threshold amount.

11. The computer program set forth in claim 10, further comprising a code segment for transmitting data representative of the changes to the remote computer only if the changes are greater than the threshold amount.

12. The computer program set forth in claim 1, wherein the portable electronic device is a tablet computer, portable computer, mobile phone, or phone-enabled portable computer.

13. A computer program stored on non-transitory computer-readable medium for directing operation of a portable electronic device operated by a caregiver while administering a treatment to a patient, the computer program comprising:
a code segment for receiving with the portable electronic device pre-treatment patient data representative of a condition of the patient before the patient receives the treatment;
a code segment for receiving with the portable electronic device treatment patient data representative of a condition of the patient while or shortly after the patient receives the treatment;
a code segment for transmitting at least some of the pre-treatment patient data and the treatment patient data from the portable electronic device to a remote computer while or shortly after the patient receives the treatment;
a code segment for receiving with the portable electronic device instructions from a doctor and instructions from a pharmacist that are provided in response to the transmitted data;
a code segment for receiving with the portable electronic device post-treatment patient data representative of a condition of the patient after the treatment, including any instructions from the doctor and instructions from the pharmacist, are completed;
a code segment for comparing the post-treatment patient data to the pre-treatment patient data or the treatment patient data and for identifying changes in the condition of the patient based on the comparison; and
a code segment for transmitting data representative of the changes to the remote computer.

14. The computer program set forth in claim 13, wherein the pre-treatment patient data, treatment patient data, and post-treatment patient data comprise results of a RODS disability score survey given to the patient.

15. The computer program set forth in claim 13, wherein the pre-treatment patient data, treatment patient data, and post-treatment patient data comprise results of a modified fatigue severity scale survey given to the patient.

16. The computer program set forth in claim 13, wherein the pre-treatment patient data, treatment patient data, and post-treatment patient data comprise results of a grip strength test given to the patient.

17. The computer program set forth in claim 13, wherein the pre-treatment patient data, treatment patient data, and post-treatment patient data comprise results of a timed up and go (TUGS) test given to the patient.

18. The computer program set forth in claim 13, wherein the instructions received from the doctor are changes to the treatment being administered to the patient and the instructions received from the pharmacist are related to a co-treatment to be administered to the patient along with the treatment.

19. The computer program set forth in claim 13, wherein the instructions received from the doctor are dosage instructions for a prescription medicine being administered to the patient as part of the treatment and the instructions received from the pharmacist are dosage instructions for a non-prescription medicine to be administered to the patient before, during, or after the treatment.

20. The computer program set forth in claim 13, wherein the portable electronic device is a tablet computer, portable computer, mobile phone, or phone-enabled portable computer.
